(19) United States
(12) Patent Application Publication
(10) Pub. No.: US 2009/0062987 A1
(43) Pub. Date: Mar. 5, 2009

(54) AUTOMATIC CONTROLLING SYSTEM FOR MAINTAINING SAFELY THE RUNNING RANGE IN THE CAR AND METHOD THEREOF

(76) Inventors: Hak Sun Kim, Annsan-si (KR); Mun Su Jeon, Chungwon-gun (KR)

Correspondence Address: Rene A. Vazquez;Williams Mullen, 8270 Greensboro Drive, Suite 700, McLean, VA, 22102, US

(21) Appl. No.: 12/281,897

(22) PCT Filed: Apr. 21, 2006
(86) PCT No.: PCT/KR06/01508

§ 371 Date: Sep. 5, 2008

(30) Foreign Application Priority Data
Mar. 7, 2006 (KR) 10-2006-0021 164

(51) Int. Cl. B60W 30/08

(52) U.S. Cl. 701/41; 701/70

(57) ABSTRACT

Disclosed is an automatic control system and method for keeping a car at a safe distance in traffic from an obstacle or other car. The inventive automatic control system comprises: a sensing device 100 for sensing a car or an obstacle in front of the system-installed car in the traveling direction; an electronic control unit (ECU) 200 connected to the sensing device 100 and receiving electric signals transmitted from the sensing device 100 as a result of sensing a car or an obstacle so as to render a control command according to a preset program; an accelerator unit 310 for automatically controlling the deceleration of the system-installed car on the basis of the electric signal from the ECU 200; a first guide stop unit 315 which operates independently of the accelerator unit 310 and controls the vertical movement of an accelerator pedal 400; a brake unit 330 for automatically controlling the braking of the system-installed car on the basis of the electric signal from the ECU 200; and a second guide stop unit 350 which operates independently of the brake unit 330 and controls the operation of a brake pedal 400′.

### TECHNICAL FIELD

The present invention relates to an automatic control system and method for keeping a car at a safe distance in traffic from an obstacle or any other car. Particularly, the present invention relates to an automatic control system and method for keeping a car at a safe distance in traffic from an obstacle or any other car in the following manner: if the car approaches a predetermined deceleration-required distance in relation to an obstacle, a command for operating a first guide stop unit, which is spaced from an accelerator pedal, and a second guide stop unit, which is connected to a brake pedal, is rendered by control signals programmed in an ECU (Electronic Control Unit) so as to sequentially operate the first guide stop unit and the second guide stop unit according to the command, so that the accelerator pedal is pushed upward in the reverse direction by a pneumatic cylinder, thereby reducing the velocity of the car, and then if the car passes the deceleration-required distance and approaches a braking-required distance in relation to the obstacle, the brake pedal is operated by the pneumatic cylinder, thereby braking the car, whereby various accidents, which may occur when a driver (in particular, a handicapped driver) incorrectly operates the accelerator pedal and/or the brake pedal due to confusion or un-skilled driving, can be prevented before they happen and the car can be automatically controlled to be kept at a safe distance in traffic from an obstacle or any other car.

### BACKGROUND ART

In general, a brake system for a car, such as a foot brake in an ordinary car or a hand/foot brake in a car for a handicapped person, employs a manual braking mechanism, which allows the ordinary car or the car for a handicapped person to be braked only when the brake is operated by a foot or by a hand.

In order to obviate accidental danger, which may be caused when a driver (in particular, a handicapped driver) incorrectly operates a brake or an accelerator due to confusion, unskilled driving or the like, Korean Utility Model Registration Publication No. 1990-405 (hereinafter, to be referred to as cited reference 1), which is issued on Jan. 30, 1990 and entitled Apparatus for Preventing Car from Collision, discloses a technique concerning an automatic braking control system, wherein a piston rod of an air cylinder allows a foot brake and a clutch to be automatically operated when an object comes close to the car from the front or rear side of the car, thereby preventing an unexpected accident.

However, because the above-mentioned apparatus for preventing a car from collision lacks a means for allowing a driver to selectively operate the apparatus as desired, there are inconveniences in that the car is stopped regardless of the driver's intention at an area, such as the downtown, where many objects exist adjacent the car, and in that the car is stopped whenever one or more objects appear from the front and/or rear side of the car regardless of the velocity of the car, whereby the car may be stopped unlike the driver's intention while the car is traveling slowly.

In order to remove the inconveniences of the apparatus of the cited reference 1, Korean Patent No. 014239 (hereinafter to be referred to as ‘cited reference 2’), which is issued on Apr. 1, 1998, discloses a automatic brake control apparatus for a car, wherein the brake control apparatus automatically operates the brake of the car on the basis of synthetic consideration of the velocity of the car and a distance between the car and an object when such an object exists in front of the car, thereby preventing an unexpected accident before it happens, and the brake control apparatus drives the brake pedal using a linear motor and an electromagnet, thereby minimizing the costs for installing the brake control apparatus.

The apparatus of cited reference 2 comprises: a selection switch (SW) which is switched on/off according to a driver's selection as to whether the braking operation is to be executed automatically or manually, thereby converting the driver's selection into an electric signal and outputting the electric signal; a light emission/reception device, which outputs an optical signal for detecting a distance between a car equipped with the apparatus and an object existing in front of the car, senses and converts the optical signal reflected by the object into an electric signal, and then outputs the electric signal; a car's velocity sensing unit which detects and converts the current velocity of the car into an electric signal and then outputs the electric signal; a control unit which determines whether an object exists at a short-distance from the car as compared to a reference distance value on the basis of the electric signal inputted from the light emission/reception device when the selection switch is switched on, and which determines whether the current velocity of the car is high or not on the basis of the signal inputted from the car's velocity sensing unit when it is determined that an object exists at a short-distance from the car as compared to the reference distance value, whereby the control unit outputs an operation signal for automatically operating the brake depending on the determined result; and a brake driver for operating a brake pedal depending on the operation signal inputted from the control unit.

However, according to cited reference 2, in a case in which an unexpected obstacle suddenly appears in front of a car while the car travels or travels with abrupt acceleration, if a driver (in particular, handicapped driver) does not discover the obstacle in advance, if the driver is confused after discovering the obstacle, or if the driver is unskilled in driving, the driver may incorrectly step on an accelerator pedal instead of stepping on a brake pedal, thereby accelerating the car without operating the brake system. If so, a large collision accident or a serious loss of life may occur.

In addition, according to cited reference 2, if the distance between the car and an obstacle in front of the car, the value of which is calculated by the control unit, is smaller than the reference distance value, the controller reads a car's velocity detection signal and determines whether the current velocity of the car exceeds a reference value. If it is determined that the current velocity of the car exceeds the reference value, the braking of the car is caused to be automatically executed. In such a case, however, if the driver continuously steps on the accelerator pedal, the braking command may be lost due to the acceleration, whereby the car continuously travels, and the continuous traveling of the car may affect the control unit to such an extent that the car travels with emergent departure, thereby causing an accident.

### DISCLOSURE OF INVENTION

### Technical Problem

Accordingly, the present invention has been made to solve the above-mentioned problems occurring in the prior art, and an object of the present invention is to provide an automatic control system and method for keeping a car at a safe distance in traffic from any other car or an obstacle in the following manner: if the car comes close to an obstacle within a predetermined deceleration-required distance, a command for operating a first guide stop unit, which is spaced from an accelerator pedal, and a second guide stop unit, which is connected to a brake pedal, is rendered by a control signal programmed in an ECU (Electronic Control Unit), so as to sequentially operate the first guide stop unit and the second guide stop unit according to the command, so that the accelerator pedal is pushed upward in the reverse direction by a pneumatic cylinder, thereby reducing the velocity of the car and then if the car passes the deceleration-required distance and approaches a braking-required distance in relation to the obstacle, the brake pedal is operated by the pneumatic cylinder, thereby braking the car, whereby various accidents, which may occur when a driver (in particular, a handicapped driver) incorrectly operates the accelerator pedal and/or the brake pedal due to confusion or un-skilled driving, can be prevented in advance and the safe distance in traffic can be automatically kept.

### Technical Solution

In order to achieve the above-mentioned object, there is provided an automatic control system for automatically keeping a car at a safe distance in traffic from any other car or an obstacle, comprising: a sensing device 100 for sensing a car or an obstacle in front of the sensing device-equipped car in the traveling direction; an ECU (Electronic Control Unit) 200 which is connected with the sensing device 100 and receives electric sensing signals which are transmitted from the sensing device 100, so as to render a control command according to a preset program; and a deceleration/braking control unit 300, wherein the deceleration/braking control unit 300 comprises: an accelerator unit 310 for automatically controlling the deceleration of the car on the basis of an electric signal from the ECU 200; a first guide stop unit 315 for controlling the upward and downward movement of the accelerate pedal 400, the first guide stop unit 300 being operated independently of the accelerator unit 310; a brake unit 330 for automatically controlling the braking of the car on the basis of an electric signal from the ECU 200; and a second guide stop unit 350 for controlling the movement of a brake pedal 400′.

According to another aspect of the present invention, there is also provided a control method for keeping a car at a safe distance in traffic from any other car or an obstacle using the inventive automatic control system, comprising steps of: initializing all sensing signals in a sensing device 100 when a main power source of the car is switched on and the accelerating operation is initiated by an accelerator pedal 400 (S20); determining whether a deceleration/braking control unit 300 is switched on, the deceleration/braking control unit being connected with the sensing device 100 and an ECU 200 (S30); projecting long-distance/short-distance optical signals to an obstacle in front of the car so as to sense the obstacle from an external sensor 110 of the sensing device 100 when the deceleration/braking control unit 300 is switched on (S40); calculating an actual distance between the car and the obstacle which is sensed in the sensing step (S40), the calculation being performed by the a calculation unit 220 of the ECU 200 (S50); determining whether the actual distance between the car and the obstacle calculated in the calculation step (S50) is larger than a reference distance value, which is referred to by a lookup table, with reference to the lookup table, which is previously stored in a ROM 260 (S60); operating a guide stop plate 40, so that the guide stop plate 40 moves so as to automatically move the accelerator pedal 400 to its original position, when the actual distance between the car and the obstacle calculated in the distance determination step (S60) is smaller than the reference distance value of the lookup table, the operation of the guide stop plate 40 being caused by a first guide stop unit 315 according to a signal transmitted to the first guide stop unit 315 from a traveling sensing device 130 through the ECU 200 (S70); and operating a brake unit 330 so as to operate a second guide stop unit 350, thereby operating the brake pedal 400′ (S80).

### ADVANTAGEOUS EFFECTS

As described above, according to the inventive automatic control system and method for keeping a car at a safe distance in traffic from an obstacle, if the car comes close to the obstacle within a predetermined deceleration-required distance in relation to an obstacle, a command for operating a first guide stop unit, which is spaced from an accelerator pedal, and a second guide stop unit, which is connected to a brake pedal, is rendered by a control signal programmed in an ECU (Electronic Control Unit), so as to sequentially operate the first guide stop unit and the second guide stop unit according to the command, so that the accelerator pedal is pushed upward in the reverse direction by a pneumatic cylinder, thereby reducing the velocity of the car and then if the car passes the deceleration-required distance and approaches a braking-required distance to the obstacle, the brake pedal is operated by the pneumatic cylinder, thereby braking the car. As a result, various accidents, which may occur when a driver (in particular, a handicapped driver) incorrectly operates the accelerator pedal and/or the brake pedal due to confusion or unskilled driving, can be prevented in advance and the safe distance in traffic can be automatically maintained. In other words, when an obstacle is positioned in front of a car within a reference distance required for braking, the inventive automatic control system and method for keeping a car at a safe distance in traffic allows automatic braking to be performed regardless of whether the driver accelerates or brakes the car due to confusion or unskilled driving, whereby the inventive system and method are useful in reducing the braking distance of the car until the driver performs a braking operation after discovering an obstacle, thereby enhancing the braking effect. In addition, as the accelerator pedal and brake pedal are automatically controlled depending on a distance between a car and an obstacle in front of the car, the velocity of the car and the weather condition around the car, while the car travels forward or travels with acceleration, it is possible to keep the car at a distance from the obstacle so as to exclude a danger of collision.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of an automatic control system for keeping a car at a safe distance in traffic from an obstacle according to an embodiment of the present invention;

FIG. 2 is a detailed block diagram of a sensing device and an electronic control unit of the inventive automatic control system for keeping a car at a safe distance in traffic from an obstacle;

FIG. 3 is a cross-sectional view showing a state in which an accelerator pedal is operated before the first guide stop unit of the deceleration/braking control unit illustrated in FIG. 1 is operated;

FIG. 4 is a cross-sectional view showing a state in which the first guide stop unit of the deceleration/braking control unit illustrated in FIG. 1 is moved upward, thereby lifting the accelerator pedal;

FIGS. 5 and 6 are cross-sectional views showing how a brake pedal is operated before the second guide stop unit of the deceleration/braking control unit is operated in the inventive automatic control system for keeping a car at a safe distance in traffic from an obstacle;

FIGS. 7 and 8 are cross-sectional views showing how the second guide stop unit 2 of the deceleration/braking control unit is operated in the inventive automatic control system for keeping a car at a safe distance in traffic from an obstacle;

FIG. 9 is a flowchart of an automatic control method for keeping a car at a safe distance in traffic from an obstacle according an embodiment of the present invention;

FIG. 10 is a flowchart showing how the first stop unit for controlling an accelerator pedal is operated in the inventive automatic control method for keeping a car at a safe distance in traffic from an obstacle; and

FIG. 11 is a flowchart showing how the brake pedal is operated after the accelerator pedal is operated in the inventive automatic control method for keeping a car at a safe distance in traffic from an obstacle.

### BEST MODE FOR CARRYING OUT THE INVENTION

Hereinafter, several preferred embodiments of the present invention will be described with reference to the accompanying drawings. The term, automatic control includes a series of procedures for operating guide stop units in connection with automatic braking through a brake pedal and automatic deceleration through an accelerator pedal, which are executed according to electric signals transmitted from a preset control program in response to approaching distances of cars which are positioned before and after, light and left a car provided with the inventive automatic control system (hereinafter, such a car may be referred to as the system-installed car for the convenience of description), or a change in weather conditions (snow or rain) around the system-installed car while traveling.

Herein, the term reverse direction of accelerator pedal means a direction opposite to the direction for stepping on the accelerator pedal, and the opposite direction is referred to as forward direction. According to the present invention, a guide stop plate of a first guide stop unit, which is installed below the accelerator pedal, moves upward so as to forcibly pushes the accelerator pedal upward, i.e., in the reverse direction.

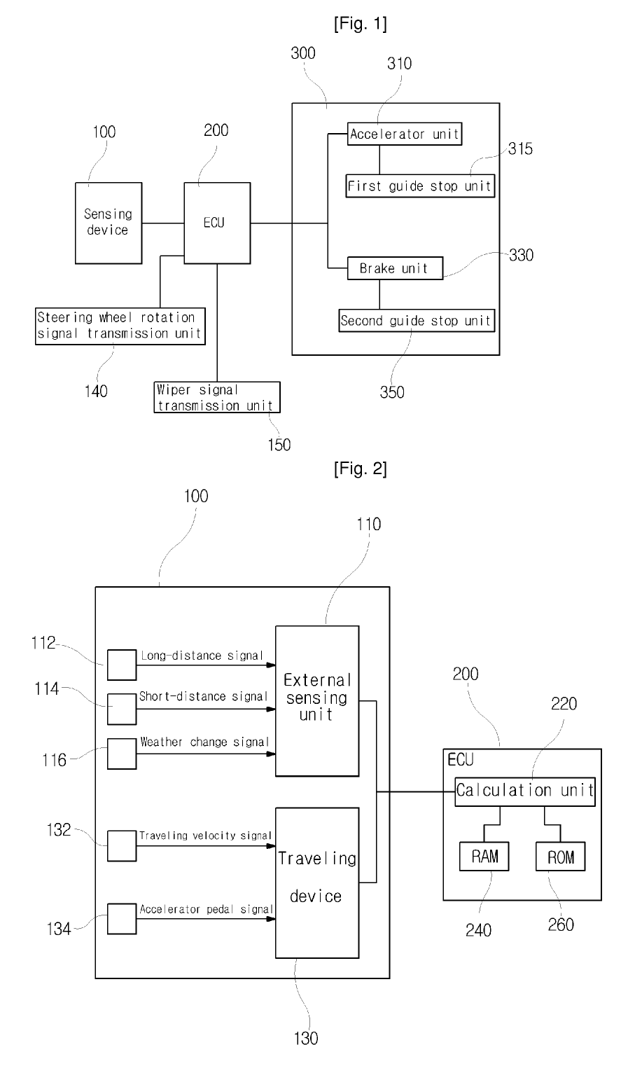

FIG. 1 is a block diagram showing the inventive automatic control system for keeping a car at a safe distance in traffic from an obstacle, wherein the inventive automatic control system comprises: a sensing device 100 for sensing a surrounding condition; an ECU (electronic control unit) 200 for receiving electric signals from the sensing device 100 so as to render a control command, the output terminal of the sensing device 100 being connected to the ECU 200; and a deceleration/braking control unit 300 which is operated by an electric signal from the ECU 200 so as to control the traveling velocity of a car.

In the inventive automatic control system, the sensing device 100, the ECU 200 and the deceleration/braking control unit 300 are switched on when a main power source of the car is turned on, and the automatic control system is activated simultaneously when the traveling velocity is increased to about 20 km/hour or more.

The deceleration/braking control unit 300 comprises: an accelerator unit 310 for automatically controlling the deceleration of the car on the basis of an electric signal from the ECU 200; a brake unit 330 for initiating the braking of the car when an obstacle comes close to the car within a predetermined distance while the car travels or travels with abrupt acceleration as the accelerator pedal 400 is operated, the brake unit 330 being operated independently of the accelerator unit 310; a first guide stop unit 315 operated by an upward or downward moving signal from the accelerator unit 310; and a second guide stop unit 350 operated by an upward or downward moving signal from the brake unit 330.

As shown in detail in FIG. 2, the sensing device 100 senses whether the system-installed car comes close to any other car within a predetermined distance to the front, rear or lateral sides of the other car while the system-installed car is traveling, turning left or right, U-turning, or being accelerated, and detects a safe distance or an approach distance in relation to an obstacle beyond such a car, and various circumferential environments, such as a change in weather conditions, which affect the traveling of the system-installed car.

The ECU 200 comprises a steering wheel rotation signal transmission unit 140 and a wiper signal transmission unit 150, which are electrically interconnected with each other.

At this time, the steering wheel rotation signal transmission unit 140 transmits an angle signal indicative of the rotation (angle) of the steering wheel of the car to the ECU 200, and the wiper signal transmission unit 150 transmits a signal indicative of a position of a wiper switch of the car to the ECU 200, independently of the steering wheel rotation signal transmission unit 140.

In addition, the steering wheel rotation signal transmission unit 140 transmits a corresponding rotation signal to the accelerator unit 310 and the brake unit 330 through the ECU 200 according to the rotating range i.e., the range of rotating angle of the steering wheel rotated by the driver at the time of turning left or right or U-turning while driving the car.

More particularly, the steering wheel rotation signal transmission unit 140 comprises switches which are switched on or off depending on the positional states of the steering wheel, i.e., a rightward turning state, a leftward turning state, and a neutral state. In this connection, the switches consist of a rightward turning switch, a leftward turning switch and a neutral switch.

That is, when the car travels along an S-course or changes the traveling direction, the steering wheel rotation signal transmission unit 140 transmits a signal as to whether the deceleration/braking control unit 300 is operated or not, depending on the rotating angle of the steering wheel, to the ECU 200. When the steering wheel is located at an angular position of 0, which is the original central position of the steering wheel corresponding to the neutral state, the steering wheel rotation signal transmission unit 140 does not transmit a steering wheel rotation signal. When the steering wheel is rotated right, the rightward turning switch is switched on and the leftward turning switch is switched, and when the steering wheel is rotated left, the leftward turning switch is switched on and the rightward turning switch is switched off.

For example, if the car turns in one direction, the steering wheel rotation signal transmission unit 140 causes the long-distance optical sensor 112, and the left and right short-distance sensors 114 to be independently operated, wherein the long-distance optical sensor 112 is positioned at the center of the bumper of the car, and the left and right short-distance sensors 114 are positioned at the opposite ends of the bumper of the car.

If an obstacle is positioned at the left side of the car when the car turns left or U-turns, the left short-distance optical sensor 114 senses the obstacle, so that the ECU 200 operates the first guide stop unit 315, thereby decelerating the car, and causes the long-distance optical sensor 112 and the right short-distance optical sensor 114 to be switched off, thereby preventing unnecessary braking which is caused as the long-distance optical sensor 112 and the right short-distance optical sensor 114 sense an obstacle which is not related to the traveling direction of the car. However, a program is set in such a manner that if the obstacle is very adjacent to the left side of the car, the first guide stop unit 315 and the second guide stop unit 350 are simultaneously operated so as to provide a braking effect, thereby preventing collision. In addition, when the car turns right, it is preferable to set the program in such a manner that the long-distance optical sensor 112 and the short-distance optical sensors 114 are operated in contrast to the above-mentioned case in which the car turns left.

As shown in FIG. 1, the wiper signal transmission unit 150 is electrically connected to the ECU 200 and transmits stepwise wiper command signals to the ECU 200, wherein the stepwise wiper command signals are generated depending on the change in weather condition if the driver operates the wiper when it rains or snows.

In addition, it is possible for the ECU 200 to connect the wiper signal transmission unit 150 to the sensing device 100, so that the wiper signal transmission unit 150 transmits electric signals to the ECU using the stepwise wiper command signals. In other words, the wiper signal transmission unit 150 may be connected to the ECU 200 together with the sensing device 100, so that the wiper signal transmission unit 150 will receive and transmit a wiper operation command to the ECU 200.

The deceleration/braking control unit 300 controls the operation of the first guide stop unit via the accelerator unit 310 when the accelerator unit 300 is operated prior to the brake unit 330 when the distance between the car and an obstacle is in a pre-determined range (by meter unit).

In addition, the deceleration/braking control unit 300 executes deceleration and braking according to a reference value, which is read out from a lookup table, wherein the lookup table is predetermined to be suitable for the change in weather (snow or rain), as the accelerator unit 310 and the brake unit 330 are operated by electric signals transmitted according to a program preset in the ECU 200.

Further, the deceleration/braking control unit 300 may comprise a second guide stop unit 350, to which the brake unit 330 separately connected to the brake unit 330 regardless of the first guide stop unit 315, which is operated according to the program preset in the ECU 200, wherein the second guide stop unit 350 is operated according to the program which is preset in the ECU 200.

Therefore, the first guide stop unit 315 and the second guide stop unit 350 are independently connected to the ECU 200 and operated according to the preset program.

Meanwhile, the first guide stop unit 315 is programmed in such a manner that information, which allows the second guide stop unit 350 to always have priority in relation to the brake unit 330 of the second guide stop unit 330, is permanently (or semi-permanently) stored in the ECU 200 once being recorded in the ECU 200, so that a driver cannot delete or correct the information.

Alternatively, the brake unit 330 may be arranged in such a way that the deceleration and braking are simultaneously switched by the first guide stop unit 315, which is switched on when an acceleration signal is forcibly transmitted as the driver forcibly operates the accelerator pedal while the short-distance optical sensor 114 operates, as well as the second guide stop unit 350.

FIG. 2 is a block diagram showing the sensing device and ECU in the inventive automatic control system for keeping a car at a safe distance in traffic from an obstacle.

In the inventive automatic control system, the sensing device 100 comprises an external sensing unit 110, which consists of long-distance/short-distance optical sensors 112 and 114, which are optical sensors for detecting distance; and a traveling sensing unit 130 which is operated simultaneously with the external sensing unit 110 so as to receive a traveling signal of the car and an operation signal of the accelerator 400.

In the sensing device 100, the external sensing unit 110 comprises long-distance/short-distance optical sensors 112 and 114, and a weather change sensor, which perform detection in response to a long-distance signal, a short-distance signal, a traveling signal, and an accelerator pedal signal, respectively, and the traveling sensing unit 130 comprises a traveling velocity signal switch 132, which senses the traveling sensor of the car itself, and an accelerator pedal switch for sensing a signal from the accelerator pedal 400 prior to the positional change of the accelerator pedal 400, which is rendered by the traveling velocity signal switch 132.

In addition, the external sensing unit 110 and the traveling sensing unit 130 are electrically connected to the ECU 200 at the output ends thereof, wherein the ECU 200 stores and calculates various signals and supplies corresponding operation commands to the external sensing unit 110 and the traveling sensing unit 130.

Further, the external sensing unit 110 consists of a plurality of individual sensing elements, which are installed on the front side, bumper or the like of the car and electrically connected to the ECU 200.

In the external sensing unit 100, the long-distance/short-distance optical sensors 114 illuminate long-distance optical sensing signals and short-distance optical sensing signals and receive signals reflected from an obstacle such as a car, thereby detecting a distance to the obstacle which is positioned in front of them.

The weather change sensor 116 of the external sensing unit 116 receives weather sensing signals, which are indicative of change in weather, according to various surrounding conditions such as snowing or raining, which may cause the long-distance/short-distance optical sensors 112 and 114 to be variable.

When the traveling velocity of the car arrives at about 20 km/hour, the traveling velocity signal switch 132 causes both the long-distance optical sensor 112 and the short-distance optical sensor 114 to be turned on according to a control signal from the ECU 200.

Depending on the traveling velocity of the car, the external sensing unit 110 primarily projects optical signals when an obstacle such as car traveling in front of the car approaches the car within a predetermined safe-distance (within a distance in the range of about 100 m to 50 m) in front of the car, and continuously detects the obstacle.

If the obstacle sensed by the long-distance optical sensor 112 approaches the car adjacent to the car within a limit distance, e.g. within about 20 m to the car, the short-distance optical sensor 114, which senses an object positioned within a distance of 20 m to the car, is secondarily operated.

If the obstacle such as a car traveling in front of the car goes away from the car over a deceleration-required distance (e.g., about 50 m), the driver is allowed to freely drive the car.

A signal outputted by the short-distance optical sensor 114 is calculated by the ECU 200, wherein long-distance signals from the long-distance optical sensor 112 and short-distance signals from the short-distance optical sensor 114 are calculated by a program which refers to the lookup table which is preset in the ECU 200.

Here, the lookup table is stored in a ROM 260, wherein various reference values as to the operating conditions of the accelerator unit 300 are previously determined and contained in the lookup table so as to control the first guide stop unit 315 and the second guide stop unit 350 illustrated in FIG. 1. That is, the lookup table contains reference values for a control signal and a traveling velocity signal, which are applied to the first guide stop unit 315 so as to decelerate the car even if the car is positioned at a normal distance from an obstacle such as a car in front of the car when the traveling velocity of the car is high, and reference values for signals which are indicative of clean weather, rainy weather, etc., respectively and applied so as to brake the car according to a weather condition. For example, as compared to the case of driving a car when it is fine, it is very difficult to observe an object such as a car traveling in front of the car from the car if the car travels at a high speed or when it rains. Furthermore, when it rains, the car slips, as a result of which the braking distance is increased. Therefore, when it rains, reference values for signals for deceleration and braking of a car are applied even if the car is positioned at a normal traveling distance from a car or an obstacle in front of the car. As such, the magnitude of a brake control signal for a car, which is in traveling or acceleration, is determined depending on a front obstacle-to-car distance signal, a traveling velocity signal and a weather condition signal, and the calculation unit 220 is driven by the control signal.

Meanwhile, as a result of the calculation of a sensing signal by the ECU 200, if the sensing signal is determined as an alarm signal or a warning signal which is stronger than a noticing signal, the ECU 200 activates and transmits an operation signal to the accelerator unit 310 while transmitting a stop signal to the brake unit 330 of the deceleration/braking control unit 300, so that the first guide stop unit 315 and the second guide stop unit 350 are operated and controlled.

Moreover, when the weather changes and it rains or snows, the ECU 200 may cause a control signal, which is supplied from the wiper signal transmission unit 150 so as to brake the car while the car is traveling in high velocity, to be determined according to a distance sensing signal for an obstacle positioned in front of the car, a traveling velocity signal and a weather condition signal.

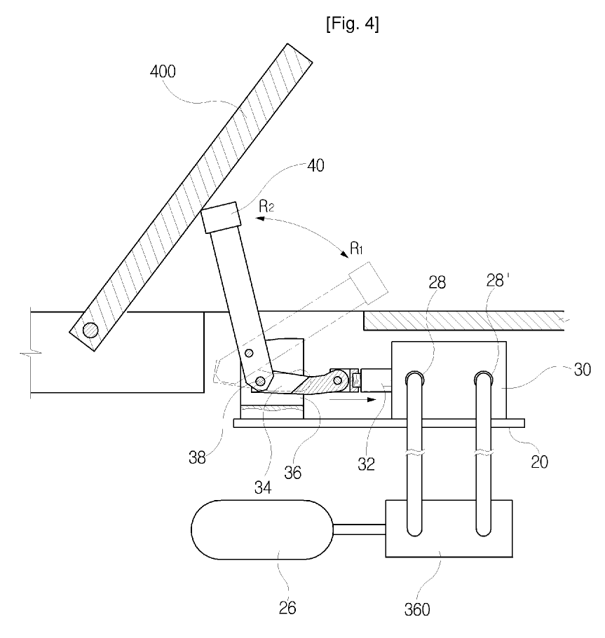

And, the wiper signal transmission unit 150 transmits a stepwise operation command for the driver of the car to operate the wiper of the car. For example, the wiper signal transmission unit 150 transmits a wiper operation command to the ECU 200, so that the first guide stop unit 315 is lifted stepwise in the ratios of 10%, 30% and 50% in the direction indicated by arrow R₁-R₂ with respect to the accelerator unit 310 as shown in FIG. 4 as the wiper is operated in first to third divided stages according to the wiper operation command which is previously programmed, for example in three steps, and stored in the wiper signal transmission unit 150.

In order to secure the forward field of vision, a driver usually operates a wiper when it rains or snows. At this time, if the driver operates the switch of the wiper in the second stage, the first guide stop unit 315 is operated.

If the first guide stop unit 315 is operated in this manner, an accelerator stop plate 40 is operated and lifted in the ratio of 50% in the reverse direction in relation to the accelerator pedal 400, thereby reducing the ratio to the reference velocity to the traveling velocity to 50% regardless of the operation of the long-distance optical sensor 112 and the short-distance optical sensor 114, so that the traveling velocity of the car is forcibly reduced, wherein the reference velocity is contained in the lookup table of the car.

In particular, because the braking distance of a car is substantially increased under a sub-zero temperature condition in which ice is formed on the road, as compared to the braking distance under a normal condition, collision due to slippage may occur if the car is abruptly braked by the operation of the second guide stop unit 350. In order to prevent this, the operation of the second guide unit 350 is programmed in such a manner as to be forcibly stopped by the weather change sensor 116, thereby decelerating the car to proper velocity while preventing the abrupt braking so as to ensure the safe traveling of the car.

Meanwhile, the ECU 200 comprises a calculation unit 220 which receives electric signals from the sensing device 100 so as to calculate long-distance/short-distance optical signals and traveling signals so that the ECU 200 operates with priority as compared to the accelerator pedal 400 and the brake pedal 400′, a RAM (Random Access Memory) 240 for temporarily storing various parameter signals generated while the car is traveling, and a ROM (Read Only Memory) 260 for permanently storing information regardless of the maintenance of a power source once the information is recorded as a program.

The calculation unit 220 is connected to the output terminal of the sensing device 100 so that the calculation unit receives and performs a control command from the sensing device 100, and if a car or an obstacle comes near to the system-installed car within the reference distance, the long-distance/short-distance optical sensors 112 and 114 as well as the traveling signal sensor of the traveling sensing unit sense the car or the obstacle and the calculation unit 220 calculates the long-distance/short distance signals and the traveling signals so that the ECU 200 operates with priority as compared to the change of the accelerator pedal 400 caused by the driver. When the long-distance optical sensor 112 detects an object positioned within a predetermined distance from the system-installed car, the ECU determines that an obstacle is positioned within the predetermined distance on the basis of the calculation by the calculation unit 220 and transmits an alarm signal to the deceleration/braking control unit 300.

In addition, the RAM 240 of the ECU 200 is electrically connected with the calculation unit 220 and stores various signals produced while the car is traveling, that is variable signals of the sensing device 100 and the wiper signal transmission unit 150.

In addition, the ROM 260 of the ECU 200 is electrically connected with the calculation unit 220 and the RAM, wherein the ROM is a memory device which does not allow deletion or correction of data or information recorded therein, whereby even if electric power is not supplied to the ROM 260, the data stored in the ROM is not temporarily erased, and the information, which is recorded as a program in the ROM, is permanently stored regardless of maintaining the power source for the ROM 260. In addition, the ROM stores data required for voice information as well as for an LCD (liquid crystal display) device installed within the car in the form of electronic signals.

In other words, if it is determined that sensing signals calculated by the calculation unit 220 of the ECU 200 indicate dangerous situation, the ECU transmits an alarm signal to the LCD device while transmitting a stop signal to the brake unit 330, so that the driver can recognize the alarm signal. In addition, the alarm signal causes the ROM 260 of the ECU 200 to output voice data previously stored in the ROM 260.

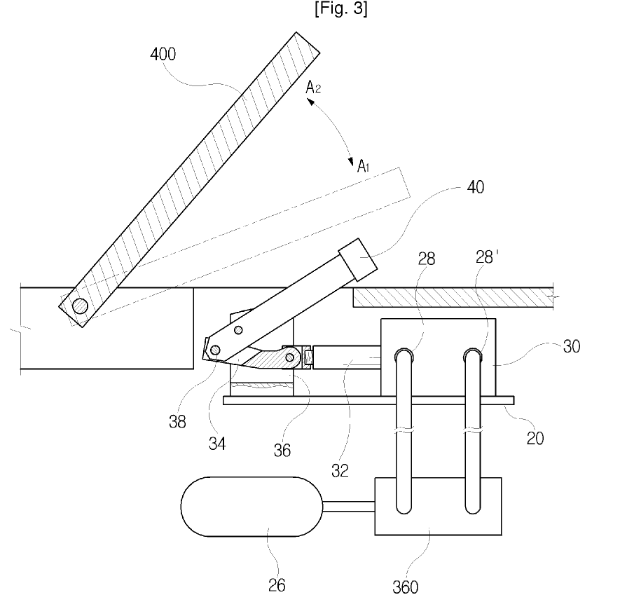

FIGS. 3 and 4 are cross-sectional views showing the acting relationship for controlling the accelerator pedal in the inventive automatic control system for keeping a car at a safe distance in traffic from any other car or an obstacle. Here, description will be made in terms of the eventual operation of the first guide stop unit 315.

FIG. 3 shows a state in which the accelerator pedal 400 is operated before the first guide stop unit 315 is operated and moved upward, and FIG. 4 shows a state in which the accelerator pedal 400 is moved as the first guide stop unit 315 is operated and moved upward.

The first guide stop unit 315 acting on the accelerator pedal 400 of a car by the ECU 200 has a mechanism for acting if a car approaches the car within a dangerous distance to the front side, the rear side or a lateral side of the car or if the car approaches an obstacle within a safe distance when the car travels forward, turns left or right, U-turns, or travels in high speed.

In FIGS. 3 and 4, the first stop unit 315 acting on the accelerator pedal 400 of the car is mechanically actuated by a solenoid 369 according to electric control signals for the accelerator unit 310, which is supplied from the ECU 200.

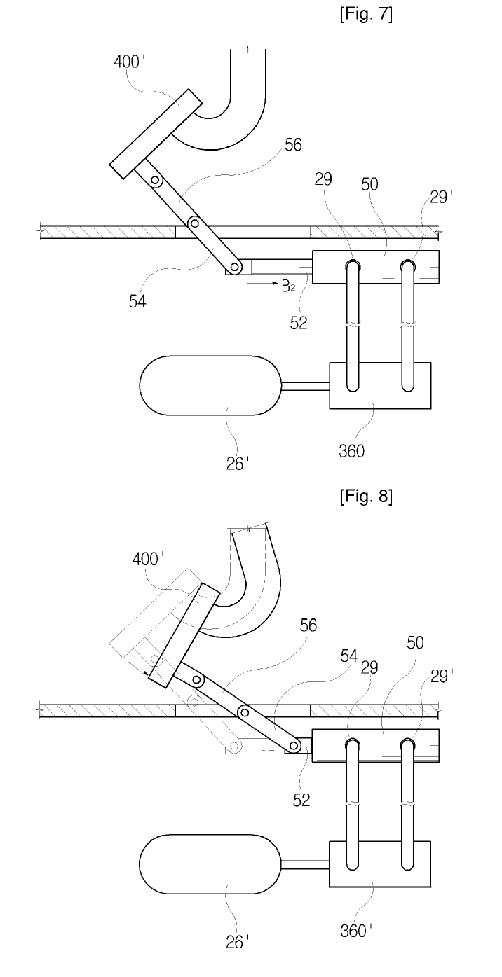

Here, when the car travels, the accelerator pedal 400 is capable of being moved upward and downward in the direction indicated by arrows A1 and A2 by the first guide stop unit 315 under the control of the ECU 200. Meanwhile, it can be appreciated from FIGS. 6 and 7 that when the braking by the brake pedal 400′ is activated so that the second guide stop 350 is to be movable, the solenoid 360′ connected to the second guide stop 350 is magnetized thereby controlling the second guide stop 350′.

Meanwhile, the solenoid 360 is connected to the accelerator unit 310 of the accelerator pedal 400 and operated according to the control command of the accelerator unit 310, which receives the control command from the ECU 200, so as to control the abrupt movement of the guide stop plate 40.

In addition, the first guide stop unit 315 comprises: a guide stop plate 40 which is spaced from the accelerator pedal 400 and moves upward and downward according to an electric signal from the solenoid 360 connected to the accelerator unit 360; a support shaft 36 for supporting the guide stop plate 40 in such a manner as to be movable upward and downward within a predetermined angular range; a link 34 which is hinged to the guide stop plate 40 and reciprocates left and right with reference to the support shaft 36; a piston rod 32 connected to the link 34; a pneumatic cylinder 30 for reciprocating the piston rod 32, the pneumatic cylinder 30 having an air inlet port 28, through which air pressure is supplied from an air compressor 26, and an air discharge port 28′ for discharging air pressure; and a base 20 for anchoring the support shaft 36 and the pneumatic cylinder 30 when the guide stop plate 40 retains its upward and downward movement according to the air pressure (Kg/cm²) which is supplied from the air compressor 26 or discharged from the pneumatic cylinder 30. Here, if the air flow direction is reversed, the air inlet port 28 and the air discharge port 28′ serve as an air discharge port and an air inlet port, respectively.

The pressure of the air compressor 26 is adjusted according to the air pressure of the air tank thereof, wherein if the pressure is increased over a predetermined level, the air compressor 25 is switched off, whereas if the air pressure of the air tank decreases below a predetermined level, the compressor 26 is switched on. The pressure can be determined by referring to the program of the ECU 200.

In addition, the air compressor 26 supplies pressure for maintaining the accelerator pedal 400 at the upwardly moved or anchored state.

The guide stop plate 40 is automatically moved upward and downward under the control command of the ECU 200, which is rendered according to a car-to-obstacle distance signal and a traveling velocity signal. Therefore, when an operation signal of the ECU 200 is applied to the accelerator unit 300, the first guide stop unit 315 controls the upward and downward movement of the accelerator pedal 400 which is cooperated with the guide stop plate 40, thereby braking the accelerator pedal 400.

At this time, as the accelerator 400 is forcibly moved upward by a signal of the ECU 200, the first guide stop unit 315 stops braking as to the accelerator pedal 400 while remaining in the upwardly moved state.

Here, an electric signal line is electrically interconnected between ECU 200 and the solenoid 360 through the accelerator unit 310 of the deceleration/braking control unit 300. That is, the signal line connects the first guide stop unit 315 with the accelerator unit 310 and air compressor 26 through the solenoid 360, which is turned on or off according to an electrical command supplied from the ECU, apart from the brake unit 330.

FIGS. 7 and 8 are cross-sectional views showing the practical acting relationship of the second guide stop 350 of the deceleration/braking control unit in the inventive automatic control system for keeping a car at a safe distance in traffic from any other car or an obstacle.

As shown in FIGS. 7 and 8, the mechanism applied to the brake pedal 400′ is configured in such a manner as to be operated according to a principle which is similar to the mechanism of the second guide stop 350 which is based on the ECU 200.

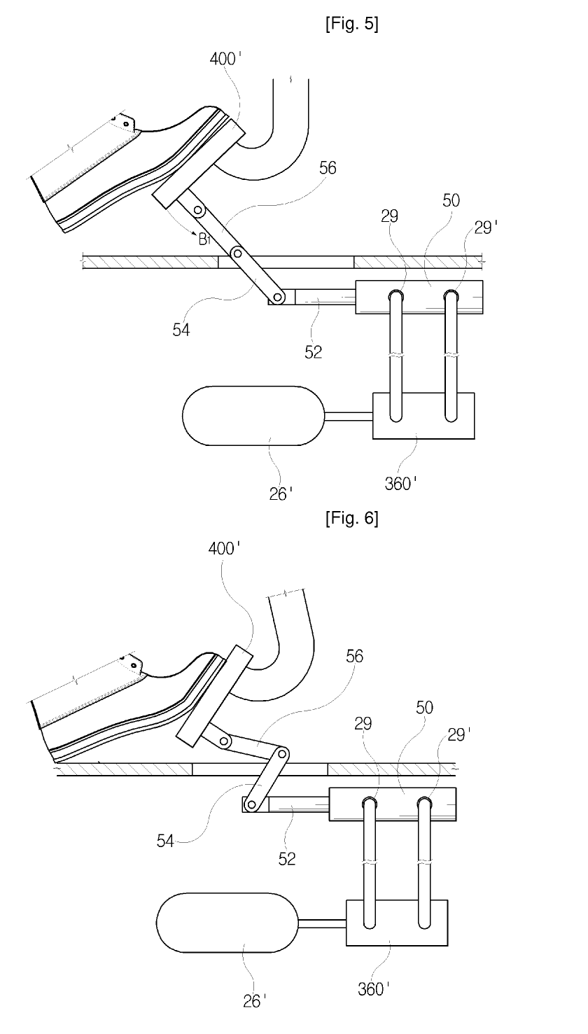

FIGS. 5 and 6 show how the inventive pneumatic cylinder 50 operates the piston rod 52, a first link 54, and a second link 56, which cause the second guide stop 350 not to operate at all when the driver compresses the brake pedal 400′ in the direction indicated by arrow B1.

FIGS. 7 and 8 show how the second guide stop 350 is operated so as to move the brake pedal 400′ according to a condition given through the external sensing unit 110 of the sensing device 100 of the car, regardless of the intention of the driver on how to drive the car.

That is, FIG. 8 shows that as the second guide stop unit 350 is operated, the piston rod 52 of the pneumatic cylinder 50 is moved in the direction indicated by arrow B2 and is then moved in the direction opposite to arrow B2, so that the first link 54 and the second link 56 are operated, thereby moving the brake pedal 400′ up and down.

The above-mentioned second guide stop unit 350 comprises: an air compressor 26′, which is operated according to an electric signal from the solenoid which is installed at the brake pedal 400′ and connected to the brake unit 330; a pneumatic cylinder 50 having an air inlet port 29, through which air pressure is supplied from the air compressor 26′, and an air discharge port 29′ for discharging air pressure, the pneumatic cylinder 50 being provided with a piston rod 52 which is reciprocated by the air pressure; and a first link 54 and a second link 56 which are hinged between the brake pedal 400′ and the piston rod 52 of the pneumatic cylinder 50.

The second guide stop unit 350 configured in this manner is operated in the same manner as the operation of the first guide stop unit 330, in that an operation signal is transferred to the second guide stop unit 350 from the ECU 200 through the brake unit 330 of the deceleration/braking control unit 300 and the second guide stop unit 350 operates the solenoid 360′.

The solenoid 360′ operated in this manner operates the air compressor 26′, which compresses air to a predetermined level of pressure and supplies the compressed air, and the air pressure supplied by the air compressor 26′ operated in this manner is supplied to the pneumatic cylinder 50 through the air inlet port 29, thereby operating the pneumatic cylinder 50.

If the solenoid 360′ operates the pneumatic cylinder 50 using the air compressor 26′ as described above, the piston rod 52 of the pneumatic cylinder 50 is operated, thereby moving the brake pedal 400′ through the first link 54 and the second link 56.

If the air flow direction is reversed in connection with the air inlet port 29 and the air discharge port 29′, the air discharge port 29′ for discharging air pressure will serve as an air inlet port 29.

Therefore, the inventive automatic control system for keeping a car at a safe distance in traffic from another car or an obstacle can secure a safe distance in traffic while the car is traveling through a mechanism in which the first guide stop unit 315 moves the guide stop plate 40 in relation to the accelerator pedal 400 so as to control the velocity of the car and a mechanism in which the second guide stop unit 350 for braking is acted on the brake pedal 400′ so as to control the velocity of the car.

The step for operating the automatic control system according to an embodiment of the present invention (S70), by which the guide stop plate 40 of the inventive automatic control system is moved upward so as to move the accelerator pedal 400 upward, will described later with reference to FIG. 5.

Now, the control method using the inventive automatic control system for keeping a car at a safe distance in traffic from another car or an obstacle will be described.

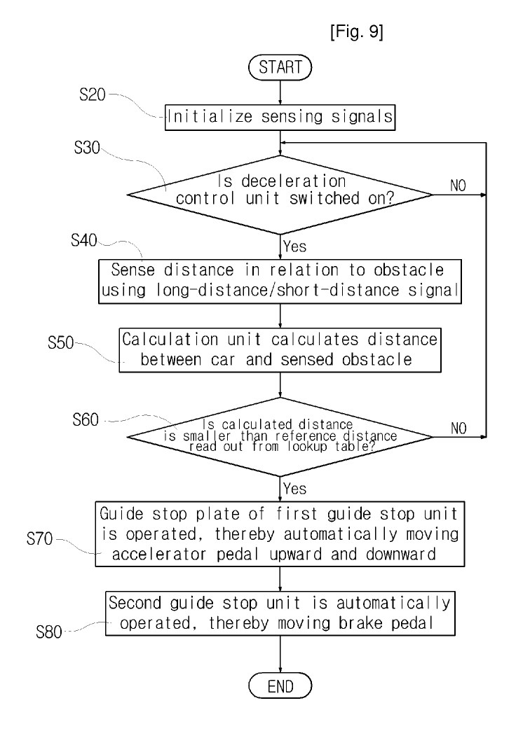

FIG. 9 is a flowchart showing the sequence of an automatic control method for decelerating or braking a car according to an embodiment of the present invention.

As shown in FIG. 9, according to the control method using the automatic control system for keeping a car at a safe distance from another car or an obstacle, a main power source of the car is initially applied, and if the acceleration through the accelerator pedal 400 is initiated, all sensing signals within the sensing device 100 are initialized (S20).

Thereafter, the ECU 200 electrically connected to the sensing device 100 determines whether the deceleration/braking control unit 300 is switched on or not (S30).

If the deceleration/braking control unit 300 is switched on, the ECU 200 renders the external sensing unit 110 of the sensing device 100 to project long-distance/short-distance signals to an obstacle positioned adjacent the car so as to sense the obstacle (S40).

If it snows or rains while performing the step of projecting long-distance/short-distance signals so as to sense the obstacle (S40) and the driver of the car operates the wiper of the car, whereby the wiper signal transmission unit 150 is operated, the wiper signal transmission unit 150 checks stepwise command signals according to a program which has been previously set for the wiper, and if it is determined that there is a change in the stepwise command signals, the wiper signal transmission unit 150 supplies stepwise signals to the ECU 200, so that the deceleration/braking control unit 300 could be driven.

In addition, the distance between the car and the obstacle, which is sensed in the sensing step S40 is calculated by the calculation unit 220 of the ECU 200 (S50). That is, the calculation unit 220 of the ECU 200 reads the sensing signals inputted from the sensing device 100 so as to calculate the distance from the car to the obstacle in front of the car.

Next, the ECU 200 determines whether the calculated distance exceeds a reference value or not. That is, it is determined whether the obstacle in front of the car is positioned near or remote from the car as compared to the reference value (S60).

If the obstacle approaches the car in the reference value determining step (S60), the guide stop plate 40 of the first guide stop unit 315 is operated. For example, if the distance determined by the ECU is in the range of about 50 to 20 m, the guide stop plate is automatically moved upward, whereas if the distance is out of this range, the guide stop plate 40 is returned to its original position.

If the traveling velocity is reduced to not more than 20 Km/hour in the reference value determining step (S60) due to the accumulation of cars on the road, the guide stop plate 40 is moved upward according to a command programmed in the ECU 200 as in the mode of operating the weather change changing device 116, so that the traveling velocity of the car is reduced to 50% of the reference velocity, which has been previously set in the lookup table of the car, thereby forcibly reducing the velocity of the car.

According to the method using the inventive automatic control system, if the accelerator pedal 400 is moved upward and downward in a state in which the main power source of the car is applied, the ECU renders a control command for the accelerator pedal 400 connected to the first guide stop unit 315 with reference to the lookup table for automatic control of the braking of the car, wherein the lookup table is programmed and stored in the ROM 260 of the ECU 200, thereby initiating the operation of the inventive automatic control system.

More specifically, if the operation of the automatic control system is initiated as described above, the ECU 200 initializes all variables stored in the internal memory and then determines whether the deceleration/braking control unit 300 is switched on or not (S30).

The deceleration/braking control unit 300 may consist of a switch which can be selectively on or off, so that the driver can brake the car as desired, wherein when the deceleration/braking control unit 300 is switched off, neither the deceleration nor the braking is automatically controlled. If the deceleration/braking control unit 300 were switched off, the ECU 200 continuously detects whether the deceleration/braking control unit 300 is switched on. However, if the deceleration/braking control unit 300 is switched on, the sensing device 100 receives sensing signals from the plural long-distance/short-distance optical sensors 112 and 114 for sensing an object in front of the car when an obstacle approaches the long-distance/short-distance optical sensors 112 and 114 and then the sensing device 100 converts the sensing signals into electric signals and outputs the electric signals to the ECU 200.

If it is determined that the obstacle in front of the car is away from the car at a distance, the value of which is larger than the reference distance value, in the reference distance value determination step (S60), the accelerator pedal 400 and the brake pedal 400′ are normally operated by the driver. However, if it is determined that the obstacle in front of the car is away from the car at a distance, the value of which is smaller than the reference distance value, that is, if the calculated obstacle-to-car distance is smaller than the reference distance value in the lookup table, in response to a signal from the traveling sensing device 130, the ECU 200 causes the first guide stop unit 315 to operate the guide stop plate 40, so that the guide stop plate moves upward, whereby the accelerator pedal 400 is automatically moved upward to its initial stop position (S70).

Next, if the accelerator pedal is operated in the step of automatically moving the accelerator pedal 400 upward (S70), air pressure is produced from the pneumatic cylinder 30 connected to the accelerator pedal 400, and the accelerator pedal 400 is released by the air pressure.

In addition, as the accelerator pedal 400 is automatically moved upward to its initial stop position and at the same time, the brake unit 330 is operated, the second guide stop unit 330 is operated, thereby moving the brake pedal 400′ (S80).

In other words, if the accelerator pedal 400 is automatically moved upward to its initial stop position, the ECU 200 commands the second guide stop unit 350 to operate the pneumatic cylinder 50. As a result, the pneumatic cylinder 50 is operated and thus the piston rod 52 connected to the first link 54 and the second link 56 is moved, whereby the brake pedal 400′ is operated and the car stops.

Therefore, if a car equipped the inventive automatic system for keeping at a safe distance in traffic from a car or an obstacle approaches within a dangerous distance in relation to a car or within a safe distance in relation to an obstacle, which is not a car, while traveling forward, turning right or left, U-turning, or traveling with abrupt acceleration, the mechanical mechanism implemented by the operation command of the ECU 200 renders the first guide stop unit 330 for acceleration to move upward in relation to the accelerator pedal 400, thereby stopping the declination of the accelerator pedal 400 so as to stop the car.

FIG. 10 is a flowchart showing how the first guide stop unit 315 for controlling the accelerator pedal is moved upward according the inventive automatic control method for keeping a car at a safe distance in traffic from other cars or obstacles.

As show in FIG. 10, in the step of automatically moving the accelerator pedal 400 upward (S70), if the car approaches within a very short distance, e.g., about 40 m, in relation to an obstacle, the accelerator unit 310 receives an operation signal, which is rendered by the long-distance/short distance sensing of the ECU 200, prior to the braking signal of the brake unit 330 (S402).

If the accelerator unit 310 receives the operation signal (S402), the solenoid 360 renders the air inlet port 28 and the air discharge port 28′ of the pneumatic cylinder 30 to be closed and opened according to a certain level of air pressure supplied or discharged from the air compressor 360 by an operation signal supplied to the input terminal thereof and an operation signal supplied to the output terminal thereof through the electric signal line of the ECU 200, respectively, so that the piston rod 32 within the pneumatic cylinder 30 is operated, thereby driving the pneumatic cylinder 30 (S404).

Thereafter, the piston rod 32 within the pneumatic cylinder 30 and the link 34 connected to the piston rod 32 are moved (S404), and the guide stop plate connected to the link 34 is moved upward; that is, the accelerator unit 310 operates the guide stop plate 40 through the solenoid 360 on the basis of an operation signal calculated by the calculation unit 220 of the ECU (S408).

Then, the guide stop plate 40 pushes upward the accelerator pedal 400, which is positioned adjacent and faces the guide stop plate 40 and cooperated with the guide stop plate, in the reverse direction in relation to the direction of pressing the accelerator pedal 400 (S410).

Therefore, according to the inventive automatic control method for keeping a car at a safe distance in traffic from another car or an obstacle, through the guide stop plate 40, the accelerator pedal 400 is operated so as to reduce the velocity of the car and the brake pedal 400 is operated so as to braking the car.

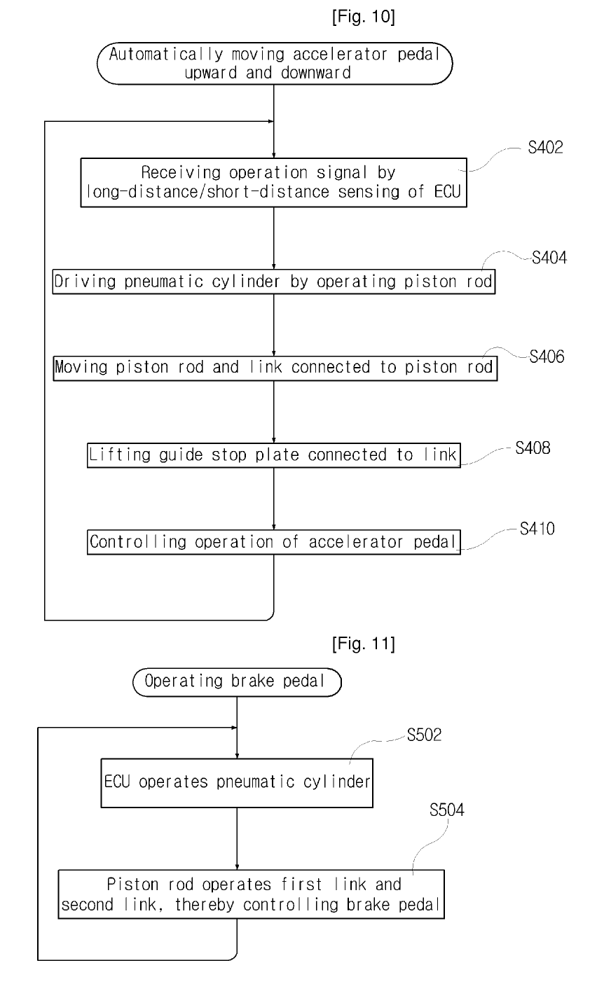

FIG. 11 is a flowchart showing how the brake pedal is operated after the accelerator pedal is operated in the inventive automatic control method for keeping a car at a safe distance in traffic from another car or an obstacle.

The method of operating the brake pedal is same with the process of operating the accelerator pedal of FIG. 9, as illustrated in FIGS. 7 and 9.

ECU 200 commands the second guide stop unit 350 to operate the pneumatic cylinder 50 through the solenoid 360′ depending on the conditions determined through the sensing device 100, the steering wheel rotation signal transmission unit 140, and the wiper signal transmission unit 150, regardless of the driver's intention in terms of driving the car (S502).

In addition, as the piston rod 52 of the pneumatic cylinder 50 (see FIG. 8), the first link 54 and the second link 56 connected to the piston rod 52 are operated (S504), and the up and down movement of the brake pedal 400′ is controlled through the links, thereby stopping the car.

If the accelerator pedal 400 is automatically moved upward and thus the car is stopped, the accelerator pedal 400 and the brake pedal 400′ return to their original positions according to the control signals from the ECU 200, in which case the guide stop plate 40 for operating the accelerator pedal 400 and the piston pedal 52 for operating the brake pedal 400′ return to their original positions.

Consequently, the inventive mechanical mechanism, in which the guide stop plate 40, which acts on the accelerator pedal 400, is moved upward, whereby pushing the accelerator pedal 400 upward so as to control the velocity of the car, operates before the car approaches within a safe distance in relation to another car or an obstacle when the car travels forward, turns right or left, U-turns, or travels with abrupt acceleration, whereby the car can be prevented from colliding with another car or the obstacle.

As described above, according to the present invention, the deceleration and braking of a car are automatically controlled on the basis of synthetic determination of the distance between the car and an obstacle in front of the car and the velocity of the car, whereby an unexpected accident can be prevented before it happens.

Although several preferred embodiments of the present invention has been described for illustrative purposes, those skilled in the art will appreciate that various modifications, additions and substitutions are possible, without departing from the scope and spirit of the invention as disclosed in the accompanying claims.

### MODE FOR THE INVENTION

Hereinafter, several preferred embodiments of the present invention will be described with reference to the accompanying drawings. The term, automatic control includes a series of procedures for operating guide stop units in connection with automatic braking through a brake pedal and automatic deceleration through an accelerator pedal, which are executed according to electric signals transmitted from a preset control program in response to approaching distances of cars which are positioned before and after, right and left of a car provided with the inventive automatic control system (hereinafter, such a car may be referred to as the system-installed car for the convenience of description), or a change in weather conditions (snow or rain) around the system-installed car while traveling.

Herein, the term reverse direction of accelerator pedal refers to a direction opposite to the direction for stepping on the accelerator pedal, and the opposite direction is referred to as forward direction. According to the present invention, a guide stop plate of a first guide stop unit, which is installed below the accelerator pedal, moves upward so as to forcibly push the accelerator pedal upward, i.e., in the reverse direction.

FIG. 1 is a block diagram showing the inventive automatic control system for keeping a car at a safe distance in traffic from an obstacle, wherein the inventive automatic control system comprises: a sensing device 100 for sensing a condition of circumference; an ECU (electronic control unit) 200 for receiving electric signals from the sensing device 100 so as to conduct a control command, the output terminal of the sensing device 100 being connected to the ECU 200; and a deceleration/braking control unit 300 which is operated by an electric signal of the ECU 200 so as to control the driving velocity of a car.

In the inventive automatic control system, the sensing device 100, the ECU 200 and the deceleration/braking control unit 300 are switched on when a main power source of the car is turned on, and the automatic control system is activated simultaneously when the driving velocity is increased to about 20 km/hour or more.

The deceleration/braking control unit 300 comprises: an accelerator unit 310 for automatically controlling the deceleration of the car on the basis of an electric signal of the ECU 200; a brake unit 330 for initiating the braking the car when an obstacle approaches the car within a predetermined distance while the car is driven or accelerated as the accelerator pedal 400, the brake unit 330 being operated independently of the accelerator unit 310; a first guide stop unit 315 operated by an upward or downward movement signal from the accelerator unit 310; and a second guide stop unit 350 operated by an upward or downward movement signal from the brake unit 330.

As shown in detail in FIG. 2, the sensing device 100 senses whether the system-installed car approaches any other car within a predetermined distance to the front, rear or lateral sides of the other car while traveling, turning left, right or even in U-turn, or being accelerated, and detects a safe distance or an approach distance to an obstacle beyond such a car, and various circumferential environments, such as change in weather conditions, which affect the travel of the system-installed car.

The ECU 200 comprises a steering wheel rotation signal transmission unit 140 and a wiper signal transmission unit 150, which are electrically interconnected with each other.

At this time, the steering wheel rotation signal transmission unit 140 transmits an angle signal indicative of the rotation (angle) of the steering wheel of the car to the ECU 200, and the wiper signal transmission unit 150 transmits a signal indicative of a position of the wiper switch of the car to the ECU 200, separately from the steering wheel rotation signal transmission unit 140.

In addition, the steering wheel rotation signal transmission unit 140 transmits a corresponding rotation signal to the accelerator unit 310 and the brake unit 330 through the ECU 200 according to the rotating range i.e., the range of rotating angle of the steering wheel rotated by the driver at the time of turning left, right or in U-turn while driving the car.

More particularly, the steering wheel rotation signal transmission unit 140 comprises switches which are turned to ON or OFF depending on the positional states of the steering wheel, i.e., a turning right state, a turning left state, and a neutral state. In this connection, the switches consist of a rightward turning switch, a leftward turning switch and a neutral switch.

That is, when the car travels along an S-course or changes the traveling direction, the steering wheel rotation signal transmission unit transmits a signal as to whether the deceleration/braking control unit 300 is operated or not, depending on the rotating angle of the steering wheel, to the ECU 200: when the steering wheel is located at an angular position of 0, which is the original central position of the steering wheel corresponding to the neutral state, the steering wheel rotation signal transmission unit 140 does not transmit a steering wheel rotation signal, when the steering wheel is rotated right, the right-turning switch is turned to ON and the left-turning switch is turned to OFF, and when the steering wheel is rotated left, the left turning switch is turned to ON and the right turning switch is turned to OFF.

For example, if the turn rotates in one direction, the steering wheel rotation signal transmission unit 140 renders the long-distance optical sensor 112, and the left and right short-distance sensors 114 to be independently operated, wherein the long-distance optical sensor 112 is positioned at the center of the bumper of the car, and the left and right short-distance sensors 114 are positioned at the opposite ends of the bumper of the car.

If an obstacle is positioned on the left of the car when the car turns left or U-turns, the left short-distance optical sensor 114 senses the obstacle, so that the ECU 200 operates the first guide stop unit 315, thereby decelerating the car, and turns the long-distance optical sensor 112 and the right short-distance optical sensor 114 to OFF, thereby preventing unnecessary braking which is caused as the long-distance optical sensor 112 and the right short-distance optical sensor 114 senses an obstacle which is not related to the travel direction of the car. However, a program is set in such a manner that if the obstacle is very adjacent to the left side of the car, the first guide stop unit 315 and the second guide stop unit 350 are simultaneously operated so as to provide a braking effect, thereby preventing collision. In addition, when the car turns right, it is preferable to set the program in such a manner that the long-distance optical sensor 112 and the short-distance optical sensors 114 are in contrast to the above-mentioned case in which the car turns left.

As shown in FIG. 1, the wiper signal transmission unit 150 is electrically connected to the ECU 200 and transmits stepwise wiper command signals to the ECU 200, wherein the stepwise wiper command signals are generated depending on the change in weather condition if the driver operates the wiper when it rains or snows.

In addition, it is possible for the ECU 200 to connect the wiper signal transmission unit 150 to the sensing device 100, so that the wiper signal transmission unit 150 transmits electric signals to the ECU using the stepwise wiper command signals. In other words, the wiper signal transmission unit 150 may be connected to the ECU 200 along with the sensing device 100, so that the wiper signal transmission unit 150 will receive and transmit a wiper operation command to the ECU.

The deceleration/braking control unit 300 controls the operation of the first guide stop unit via the accelerator unit 310 when the accelerator unit is operated prior to the brake unit 330 when the distance between the car and an obstacle is within a pre-determined range (by meter unit).

In addition, the deceleration/braking control unit 300 executes deceleration and braking according to a reference value referenced by a lookup table, which is pre-determined to be suitable to the change in weather (snow or rain), as the accelerator unit 310 and the brake unit 330 are operated by electric signals transmitted according to a preset program of the ECU 200.

Further, the deceleration/braking control unit 300 may comprise a second guide stop unit 350, to which the brake unit 330 separately connected to the brake unit 330 regardless of the first guide stop unit 315, which is operated according to the program which is preset in the ECU 200, wherein the second guide stop unit 350 is operated according to the program which is preset in the ECU 200.

Therefore, the first guide stop unit 315 and the second guide stop unit 350 are independently connected to the ECU 200 and operated according to the preset program.

Meanwhile, the first guide stop unit 315 is programmed in such a manner that information, which renders the second guide stop unit 350 to always have priority as compared with the brake unit 330 of the second guide stop unit 330, is (semi) permanently stored in the ECU 200 once being recorded in the ECU, so that a driver cannot delete or correct the information.

Alternatively, the brake unit 330 may be arranged in such a way that the deceleration and braking are simultaneously switched by the first guide stop unit 315, which is switched ON when an acceleration signal is forcibly transmitted as the driver forcibly operates the accelerator pedal while the short-distance optical sensor 114 operates, as well as the second guide stop unit 350.

FIG. 2 is a block diagram showing the sensing device and ECU in the inventive automatic control system for keeping a car at a safe distance in traffic from an obstacle.

In the inventive automatic control system, the sensing device 100 comprises an external sensing unit 110, which consists of a long-distance optical sensor 112 and a short-distance optical sensor 114, which are optical sensors for detecting distance; an a traveling sensing unit 130 which is operated simultaneously with the external sensing unit 110 so as to receive a traveling signal of the car and an operation signal of the accelerator 400.

In the sensing device 100, the external sensing unit 110 comprises a long-distance optical sensor 112, a short-distance optical sensor 114, and a weather change sensor, which perform detection in response to a long-distance signal, a short-distance signal, a traveling signal, and an accelerator pedal signal, respectively, and the traveling sensing unit 130 comprises a traveling velocity signal switch 132, which senses the traveling sensor of the car itself, and an accelerator pedal switch for sensing a signal from the accelerator pedal 400 prior to the positional change of the accelerator pedal 400, which is rendered by the traveling velocity signal switch 132.

In addition, the external sensing unit 110 and the traveling sensing unit 130 are electrically connected to the ECU 200 at the output ends thereof, wherein the ECU 200 stores and calculates various signals and supplies corresponding operation commands to the external sensing unit 110 and the traveling sensing unit 130.

Further, the external sensing unit 110 consists of a plurality of individual sensing elements, which are installed on the front side, bumper or the like of the car and electrically connected to the ECU 200.

In the external sensing unit 100, the long-distance optical sensor 112 and the short-distance optical sensor 114 illuminate long-distance optical sensing signals and short-distance optical sensing signals and receive signals reflected from an obstacle such as a car, thereby detecting a distance to the obstacle which is positioned in front of them.

The weather change sensor 116 of the external sensing unit 116 receives weather sensing signals, which are indicative of change in weather, according to various surrounding conditions such as snowing or raining, which may cause the long-distance/short-distance optical sensors 112 and 114 to be variable.

When the traveling velocity of the car is about 20 km/hour, the traveling velocity signal switch 132 switches both the long-distance optical sensor 112 and the short-distance optical sensor 114 on according to a control signal from the ECU 200.

Depending on the traveling velocity of the car, the external sensing unit 110 primarily illuminates optical signals when an obstacle such as car traveling in front of the car approaches the car within a predetermined safe-distance (within a distance in the range of about 100 m to 50 m) in front of the car, and continuously detects the obstacle.

If the obstacle sensed by the long-distance optical sensor 112 approaches the car adjacent to the car within a limit distance, e.g. within about 20 m to the car, the short-distance optical sensor 114, which senses an object within 20 m, is secondarily operated.

If the obstacle such as a car traveling in front of the car goes away from the car over a deceleration-required distance (e.g., about 50 m), the driver is allowed to freely drive the car.

A signal outputted by the short-distance optical sensor 114 is calculated by the ECU 200, wherein long-distance signals from the long-distance optical sensor 112 and short-distance signals from the short-distance optical sensor 114 are calculated by a program which refers to the lookup table which is preset by the ECU 200.

Here, the lookup table is stored in an ROM 260, wherein various reference values as to the operating conditions of the accelerator unit 300 are previously determined and contained in the lookup table so as to control the first guide stop unit 315 and the second guide stop unit 350 illustrated in FIG. 1. That is, the lookup table contains reference values for a control signal and a traveling velocity signal, which are applied to the first guide stop unit 315 so as to decelerate the car even if the car is positioned at a normal distance from an obstacle such as a car in front of the car when the traveling velocity of the car is high, and reference values for signals which are indicative of calm weather, rainy weather, etc., respectively and applied to brake the car according to the weather conditions. For example, as compared to the case of driving a car when the weather is fine, it is very difficult to observe an object such as a car traveling in front of the car from the car if the car travels at a high speed or when it rains. Furthermore, when it rains, the car slips, as a result of which the distance required for braking and intensity of braking increase. Therefore, when it rains, reference values for signals for deceleration and braking of a car are applied even if the car is positioned at a normal traveling distance from a car or an obstacle in front of the car. As such, the magnitude of a brake control signal for a car which is traveling or accelerating is determined depending on a front obstacle-to-car distance signal, a traveling velocity signal and a weather condition signal, and the calculation unit 220 is driven by the control signal.

Meanwhile, as a result of the ECU 200 calculating a sensing signal, if the sensing signal is determined to be an alarm signal or a warning signal which is stronger than a noticing signal, the ECU 200 transmits and activates an operation signal to the accelerator unit 310 while transmitting a stop signal to the brake unit 330 of the deceleration/braking control unit 300, so that the first guide stop unit 315 and the second guide stop unit 350 are operated and controlled.

Moreover, when the weather is changed and it rains or snows, the ECU 200 may cause a control signal supplied from the wiper signal transmission unit 150 so as to brake the car while the car is traveling in high velocity, to be determined according to a distance sensing signal for an obstacle positioned in front of the car, a traveling velocity signal and a weather condition signal.

And, the wiper signal transmission unit 150 transmits a stepwise operation command for the driver of the car to operate the wiper of the car. For example, the wiper signal transmission unit 150 transmits a wiper operation command to the ECU 200, so that the first guide stop unit 315 is lifted stepwise in the ratios of 10%, 30% and 50% in the direction indicated by arrow R₁-R₂ with respect to the accelerator unit 310 as shown in FIG. 4 as the wiper is operated in first to third divided stages according to the wiper operation command which were previously programmed, for example in three steps, and stored in the wiper signal transmission unit 150.

In order to obtain a forward view, a driver usually operates a wiper when it rains or snows. At this time, if the driver operates the switch of the wiper in the second stage, the first guide stop unit 315 is operated.

If the first guide stop unit 315 is operated in this manner, an accelerator stop plate 40 is operated and lifted in the ratio of 50% in the reverse direction in relation to the accelerator pedal 400, thereby reducing the ratio of the reference velocity to the traveling velocity to 50% regardless of the operation of the long-distance optical sensor 112 and the short-distance optical sensor 114, so that the traveling velocity of the car is forcibly decelerated, wherein the reference velocity is contained in the lookup table of the car.

In particular, because the braking distance of a car is substantially increased under a sub-zero temperature condition in which ice is formed on the road, as compared to under normal conditions, collision due to slippage may occur if the car is abruptly braked by the operation of the second guide stop unit 350. In order to prevent this, the operation of the second guide unit 350 is programmed in such a manner as to be forcibly stopped by the weather change sensor 116, thereby slowing down the car to proper velocity while preventing the abrupt braking so as to ensure safe traveling of the car.

Meanwhile, the ECU 200 comprises a calculation unit 220 which receives electric signals from the sensing device 100 so as to calculate long-distance/short-distance optical signals and traveling signals so that the ECU 200 operates with priority as compared to the accelerator pedal 400 and the brake pedal 400′, a RAM (Random Access Memory) 240 for temporarily storing various parameter signals generated while the car is traveling, and a ROM (Read Only Memory) 260 for permanently storing information regardless of the maintenance of a power source once the information is recorded as a program.

The calculation unit 220 is connected to the output terminal of the sensing device 100 so that the calculation unit receives and performs a control command from the sensing device 100, and if a car or an obstacle approaches within the reference distance, the long-distance/short-distance optical sensors 112 and 114 as well as the traveling signal sensor of the traveling sensing unit sense the car or the obstacle and the calculation unit 220 calculates the long-distance/short distance signals and the traveling signals so that the ECU 200 operates with priority as compared to the change of the accelerator pedal 400 caused by the driver. When the long-distance optical sensor 112 detects an object positioned within a predetermined distance, the ECU determines that an obstacle is positioned within the predetermined distance on the basis of the calculation by the calculation unit 220 and transmits an alarm signal to the deceleration/braking control unit 300.

In addition, the RAM 240 of the ECU 200 is electrically connected with the calculation unit 220 and stores various signals produced while the car is traveling, that is variable signals of the sensing device 100 and the wiper signal transmission unit 150.

In addition, the ROM 260 of the ECU 200 is electrically connected with the calculation unit 220 and the RAM, wherein the ROM is a memory device which does not allow deletion or modification of data or information recorded therein, whereby even if electric power is not supplied to the ROM 260, the data stored in the ROM is not temporarily erased, and the information, which is recorded as a program in the ROM, is permanently stored regardless of maintaining the power source for the ROM 260. In addition, the ROM stores data required for voice information as well as for an LCD (liquid crystal display) device installed within the car in the form of electronic signals.

In other words, if it is determined that sensing signals calculated by the calculation unit 220 of the ECU indicate dangerous situation, the ECU transmits an alarm signal to the LCD device while transmitting a stop signal to the brake unit 330, so that the driver can recognize the alarm signal. In addition, the alarm signal renders the ROM 260 of the ECU 200 to output voice data previously stored in the ROM 260.

FIGS. 3 and 4 are cross-sectional views showing the acting relationship for controlling the accelerator pedal in the inventive automatic control system for keeping a car at a safe distance in traffic from other car or an obstacle. Here, description will be made in terms of the practical operation of the first guide stop unit 315.

FIG. 3 shows a state in which the accelerator pedal 400 is operated before the first guide stop unit 315 is operated and moved upward, and FIG. 4 shows a state in which the accelerator pedal 400 is moved as the first guide stop unit 315 is operated and moved upward.

The first guide stop unit 315 acted on the accelerator pedal 400 of a car by the ECU 200 has a mechanism of acting if a car approaches the car within a dangerous distance to the front side, the rear side or a lateral side of the car or if the car approaches an obstacle within a safe distance when the car travels forward, turns left or right, U-turns, or travels at a high speed.

In FIGS. 3 and 4, the first stop unit 315 acting on the accelerator pedal 400 of the car is mechanically actuated by a solenoid 369 according to an electric control signal for the accelerator unit 310, which is supplied from the ECU 200.

Here, when the car travels, the accelerator pedal 400 is capable of being moved up or down in the direction indicated by arrows A1 and A2 by the first guide stop unit 315 under the control of the ECU 200. Meanwhile, it can be appreciated from FIGS. 6 and 7 that when the braking by the brake pedal 400′ is activated so that the second guide stop 350 is to be movable, the solenoid 360′ connected to the second guide stop 350 controls the second guide stop 350′ by being magnetized.

Meanwhile, the solenoid 360 is connected to the accelerator unit 310 of the accelerator pedal 400 and is operated according to the control command of the accelerator unit 310, which receives the control command from the ECU 200, so as to control the abrupt movement of the guide stop plate 40.

In addition, the first guide stop unit 315 comprises: a guide stop plate 40 which is spaced from the accelerator pedal 400 and moves up and down according to an electric signal from the solenoid 360 connected to the accelerator unit 360; a support shaft 36 for supporting the guide stop plate 40 in such a manner as to be movable up and down within a predetermined angular range; a link 34 which is hinged to the guide stop plate 40 and reciprocates left and right with reference to the support shaft 36; a piston rod 32 connected to the link 34; a pneumatic cylinder 30 for reciprocating the piston rod 32, the pneumatic cylinder 30 having an air inlet port 28, through which air pressure is supplied from an air compressor 26, and an air discharge port 28′ for discharging air pressure; and a base 20 for anchoring the support shaft 36 and the pneumatic cylinder 30 when the guide stop plate 40 retains its upward and downward movement according to the air pressure (Kg/cm²) which is supplied from the air compressor 26 or discharged from the pneumatic cylinder 30. Here, if the air flow direction is reversed, the air inlet port 28 and the air discharge port 28′ serve as an air discharge port and an air inlet port, respectively.

The pressure of the air compressor 26 is adjusted according to the air pressure of the air tank thereof, wherein if the pressure is increased over a predetermined level, the air compressor 25 is switched off, whereas if the air pressure of the air tank decreases below a predetermined level, the compressor 26 is switched on. The pressure can be determined by referring to the program of the ECU 200.

In addition, the air compressor 26 supplies pressure for maintaining the accelerator pedal 400 at the upwardly moved or anchored state.

The guide stop plate 40 is automatically moved up and down under the control command of the ECU 200, which is rendered according to a car-to-obstacle signal and a traveling velocity signal. Therefore, when an operation signal of the ECU 200 is applied to the accelerator unit 300, the first guide stop unit 315 controls the upward and downward movement of the accelerator pedal 400 which is cooperated with the guide stop plate 40, thereby braking the accelerator pedal 400.

At this time, as the accelerator 400 is forcibly moved upward by a signal from the ECU 200, the first guide stop unit 315 stops braking as to the accelerator pedal 400 while remaining in the upwardly moved state.

Here, an electric signal line is electrically interconnected between the ECU 200 and the solenoid 360 through the accelerator unit 310 of the deceleration/braking control unit 300. That is, the signal line connects the first guide stop unit 315 with the accelerator unit 310 and the air compressor 26 through the solenoid 360, which is turned on or off according to an electrical command supplied from the ECU, apart from the brake unit 330.

FIGS. 7 and 8 are cross-sectional views showing the practical acting relationship of the second guide stop 350 of the deceleration/braking control unit in the inventive automatic control system for keeping a car at a safe distance in traffic from another car or an obstacle.

As shown in FIGS. 7 and 8, the mechanism applied to the brake pedal 400′ is configured in such a manner as to be operated according to a principle which is similar to the mechanism of the second guide stop 350 which is based on the ECU 200.

FIGS. 5 and 6 show how the inventive pneumatic cylinder 50 operates the piston rod 52, a first link 54, and a second link 56, which cause the second guide stop 350 not to operate at all, when the driver compresses the brake pedal 400′ in the direction indicated by arrow B1.

FIGS. 7 and 8 show how the second guide stop 350 is operated so as to move the brake pedal 400′ according to a condition given through the external sensing unit 110 of the sensing device 100 of the car, regardless of the intention of the driver on how to drive the car.

That is, FIG. 8 shows that as the second guide stop unit 350 is operated, the piston rod 52 of the pneumatic cylinder 50 is moved in the direction indicated by arrow B2 and then moved in the direction opposite to arrow B2, so that the first link 54 and the second link 56 are operated, thereby moving the brake pedal 400′ up and down.

The above-mentioned second guide stop unit 350 comprises: an air compressor 26′, which is operated according to an electric signal from the solenoid which is installed at the brake pedal 400′ and connected to the brake unit 330; a pneumatic cylinder 50 having an air inlet port 29, through which air pressure is supplied from the air compressor 26′, and an air discharge port 29′ for discharging air pressure, the pneumatic cylinder 50 being provided with a piston rod 52 which is reciprocated by the air pressure; a first link 54 and a second link 56 which are hinged between the brake pedal 400′ and the piston rod 52 of the pneumatic cylinder 50.

The second guide stop unit 350 configured in this manner is operated in a same manner as the operation of the first guide stop unit 330 in that an operation signal is transferred to the second guide stop unit 350 from the ECU 200 through the brake unit 330 of the deceleration/braking control unit 300 and the second guide stop unit 350 operates the solenoid 360′.

The solenoid 360′ operated in this manner operates the air compressor 26′, which compresses air to a predetermined level of pressure and supplies the compressed air, and the air pressure supplied by the air compressor 26′ operated in this manner is supplied to the pneumatic cylinder 50 through the air inlet port 29, thereby operating the pneumatic cylinder 50.

If the solenoid 360′ operates the pneumatic cylinder 50 using the air compressor 26′ as described above, the piston rod 52 of the pneumatic cylinder 50 is operated, thereby moving the brake pedal 400′ through the first link 54 and the second link 56.

If the air flow direction is reversed in connection with the air inlet port 29 and the air discharge port 29′, the air discharge port 29′ for discharging air pressure will serve as an air inlet port 29.

Therefore, the inventive automatic control system for keeping a car at a safe distance in traffic from another car or an obstacle can secure a safe distance in traffic while the car is traveling through a mechanism in which the first guide stop unit 315 moves the guide stop plate 40 in relation to the accelerator pedal 400 so as to control the velocity of the car and a mechanism in which the second guide stop unit 350 for braking is acted on the brake pedal 400′ so as to control the velocity of the car.

The step for operating the automatic control system according to an embodiment of the present invention (S70), by which the guide stop plate 40 of the inventive automatic control system is moved upward so as to move the accelerator pedal 400 upward, will described later with reference to FIG. 5.

Now, the control method using the inventive automatic control system for keeping a car at a safe distance in traffic from another car or an obstacle will be described.

FIG. 9 is a flowchart showing the sequence of an automatic control method for decelerating or braking a car according to an embodiment of the present invention.

As shown in FIG. 9, according to the control method using the automatic control system for keeping a car at a safe distance from another car or an obstacle, a main power source of the car is initially applied, and if the acceleration through the accelerator pedal 400 is initiated, all sensing signals within the sensing device 100 are initialized (S20).

Thereafter, the ECU 200 electrically connected to the sensing device 100 determines whether the deceleration/braking control unit 300 is switched on or not (S30).

If the deceleration/braking control unit 300 is switched on, the ECU 200 renders the external sensing unit 110 of the sensing device 100 to project long-distance/short-distance signals to an obstacle positioned adjacent the car so as to sense the obstacle (S40).

If it snows or rains while performing the step of projecting long-distance/short-distance signals so as to sense the obstacle (S40) and the driver of the car operates the wiper of the car, whereby the wiper signal transmission unit 150 is operated, the wiper signal transmission unit 150 checks stepwise command signals according to a program which has been previously set for the wiper, and if it is determined that there is a change in the stepwise command signals, the wiper signal transmission unit 150 supplies stepwise signals to the ECU 200, so that the deceleration/braking control unit 300 can be driven.

In addition, the distance between the car and the obstacle, which is sensed in the sensing step S40 is calculated by the calculation unit 220 of the ECU 200 (S50). That is, the calculation unit 220 of the ECU 200 reads the sensing signals input from the sensing device 100 so as to calculate the distance from the car to the obstacle in front of the car.

Next, the ECU 200 determines whether the calculated distance exceeds a reference value or not. That is, it is determined whether the obstacle in front of the car is positioned near or remote from the car as compared to the reference value (S60).

If the obstacle approaches the car within the reference value determining step (S60), the guide stop plate 40 of the first guide stop unit 315 is operated. For example, if the distance determined by the ECU is in the range of about 50 to 20 m, the guide stop plate is automatically moved upward, whereas if the distance is out of this range, the guide stop plate 40 is returned to its original position.

If the traveling velocity is reduced to not more than 20 Km/hour in the reference value determining step (S60) due to the accumulation of cars on the road, the guide stop plate 40 is moved upward according to a command programmed in the ECU 200 as in the mode of operating the weather change changing device 116, so that the traveling velocity of the car is reduced to 50% of the reference velocity, which has been previously set in the lookup table of the car, thereby forcibly reducing the velocity of the car.

According to the method using the inventive automatic control system, if the accelerator pedal 400 is moved upward and downward in a state in which the main power source of the car is applied, the ECU renders a control command for the accelerator pedal 400 connected to the first guide stop unit 315 with reference to the lookup table for automatic control of the braking of the car, wherein the lookup table is programmed and stored in the ROM 260 of the ECU 200, thereby initiating the operation of the inventive automatic control system.

More specifically, if the operation of the automatic control system is initiated as described above, the ECU 200 initializes all variables stored in the internal memory and then determines whether the deceleration/braking control unit 300 is switched on or not (S30).

The deceleration/braking control unit 300 may consist of a switch which can be selectively on or off, so that the driver can brake the car as desired, wherein when the deceleration/braking control unit 300 is switched off, neither the deceleration nor the braking is automatically controlled. If the deceleration/braking control unit 300 were switched off, the ECU 200 continuously detects whether the deceleration/braking control unit 300 is switched on. However, if the deceleration/braking control unit 300 is switched on, the sensing device 100 receives sensing signals from the plural long-distance/short-distance optical sensors 112 and 114 for sensing an object in front of the car when an obstacle approaches the long-distance/short-distance optical sensors 112 and 114 and then the sensing device 100 converts the sensing signals into electric signals and outputs the electric signals to the ECU 200.

If it is determined that the obstacle in front of the car is away from the car at a distance, the value of which is larger than the reference distance value, in the reference distance value determination step (S60), the accelerator pedal 400 and the brake pedal 400′ are normally operated by the driver. However, if it is determined that the obstacle in front of the car is away from the car at a distance, the value of which is smaller than the reference distance value, that is, if the calculated obstacle-to-car distance is smaller than the reference distance value in the lookup table, in response to a signal from the traveling sensing device 130, the ECU 200 causes the first guide stop unit 315 to operate the guide stop plate 40, so that the guide stop plate moves upward, whereby the accelerator pedal 400 is automatically moved upward to its initial stop position (S70).

Next, if the accelerator pedal is operated in the step of automatically moving the accelerator pedal 400 upward (S70), air pressure is produced from the pneumatic cylinder 30 connected to the accelerator pedal 400, and the accelerator pedal 400 is released by the air pressure.

In addition, as the accelerator pedal 400 is automatically moved upward to its initial stop position and at the same time, the brake unit 330 is operated, the second guide stop unit 330 is operated, thereby moving the brake pedal 400′ (S80).

In other words, if the accelerator pedal 400 is automatically moved upward to its initial stop position, the ECU 200 commands the second guide stop unit 350 to operate the pneumatic cylinder 50. As a result, the pneumatic cylinder 50 is operated and thus the piston rod 52 connected to the first link 54 and the second link 56 is moved, whereby the brake pedal 400′ is operated and the car stops.

Therefore, if a car equipped the inventive automatic system for keeping a car at a safe distance in traffic from a car or an obstacle approaches within a dangerous distance in relation to a car or within a safe distance in relation to an obstacle, which is not a car, while traveling forward, turning right or left, U-turning, or traveling with abrupt acceleration, the mechanical mechanism implemented by the operation command of the ECU 200 renders the first guide stop unit 330 for acceleration to move upward in relation to the accelerator pedal 400, thereby stopping the declination of the accelerator pedal 400 so as to stop the car.

FIG. 10 is a flowchart showing how the first guide stop unit 315 for controlling the accelerator pedal is moved upward according the inventive automatic control method for keeping a car at a safe distance in traffic from other car.

As shown in FIG. 10, in the step of automatically moving the accelerator pedal 400 upward (S70), if the car approaches within a very short distance, e.g., about 40 m, in relation to an obstacle, the accelerator unit 310 receives an operation signal, which is rendered by the long-distance/short distance sensing of the ECU 200, prior to the braking signal of the brake unit 330 (S402).

If the accelerator unit 310 receives the operation signal (S402), the solenoid 360 renders the air inlet port 28 and the air discharge port 28′ of the pneumatic cylinder 30 to be closed and opened according to a certain level of air pressure supplied or discharged from the air compressor 360 by an operation signal supplied to the input terminal thereof and an operation signal supplied to the output terminal thereof through the electric signal line of the ECU 200, respectively, so that the piston rod 32 within the pneumatic cylinder 30 is operated, thereby driving the pneumatic cylinder 30 (S404).

Thereafter, the piston rod 32 within the pneumatic cylinder 30 and the link 34 connected to the piston rod 32 are moved (S404), and the guide stop plate connected to the link 34 is moved upward; that is, the accelerator unit 310 operates the guide stop plate 40 through the solenoid 360 on the basis of an operation signal calculated by the calculation unit 220 of the ECU (S408).

Then, the guide stop plate 40 pushes upward the accelerator pedal 400, which is positioned adjacent and faces the guide stop plate 40 and cooperated with the guide stop plate, in the reverse direction in relation to the direction of pressing the accelerator pedal 400 (S410).

Therefore, according to the inventive automatic control method for keeping a car at a safe distance in traffic from another car or an obstacle, through the guide stop plate 40, the accelerator pedal 400 is operated so as to reduce the velocity of the car and the brake pedal 400 is operated so as to braking the car.

FIG. 11 is a flowchart showing how the brake pedal is operated after the brake pedal is operated in the inventive automatic control method for keeping a car at a safe distance in traffic from another car or an obstacle.

The method of operating the brake pedal is same with the process of operating the accelerator pedal of FIG. 9, as illustrated in FIGS. 7 and 9.

ECU 200 commands the second guide stop unit 350 to operate the pneumatic cylinder 50 through the solenoid 360′ depending on the conditions determined through the sensing device 100, the steering wheel rotation signal transmission unit 140, and the wiper signal transmission unit 150, regardless of the driver's intention in terms of how to drive the car (S502).

In addition, as the piston rod 52 of the pneumatic cylinder 50 (see FIG. 8), the first link 54 and the second link 56 connected to the piston rod 52 are operated (S504), and the up and down movement of the brake pedal 400′ is controlled through the links, thereby stopping the car.

If the accelerator pedal 400 is automatically moved upward and thus the car is stopped, the accelerator pedal 400 and the brake pedal 400′ return to their original positions according to the control signals from the ECU 200, in which case the guide stop plate 40 for operating the accelerator pedal 400 and the piston pedal 52 for operating the brake pedal 400′ return to their original positions.

Consequently, the inventive mechanical mechanism, in which the guide stop plate 40, which acts on the accelerator pedal 400, is moved upward, whereby pushing the accelerator pedal 400 upward so as to control the velocity of the car, operates before the car comes within a safe distance in relation to another car or an obstacle when the car travels forward, turns right or left, U-turns, or travels with abrupt acceleration, whereby the car can be prevented from colliding with the another car or the obstacle.

As described above, according to the present invention, the deceleration and braking of a car are automatically controlled on the basis of synthetic determination of the distance between the car and an obstacle in front of the car and the velocity of the car, whereby an unexpected accident can be prevented before it happens.

Although several preferred embodiments of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention has an advantage in that if a car comes within a pre-determined distance in relation to an obstacle due to a driver (in particular, a handicapped driver) incorrectly operating an accelerator pedal and/or a brake pedal due to confusion or unskilled driving, the car can be automatically decelerated and braked, so that the collision of the car can be prevented and a safe distance in traffic can be secured.

In addition, the present invention has an advantage in that at the moment a critical situation of collision is detected, which may occur suddenly when a car passes by another car or an obstacle, the first guide stop unit and the second guide stop unit are operated concurrently according to an operation command of the ECU 200 so as to forcibly move the accelerator pedal upward, thereby abruptly braking the car by operating the brake pedal 400′ while preventing the car from being accelerated as the accelerator pedal 400 is operated by a driver, as a result of which various accidents, which may occur as a driver (in particular, a handicapped driver) incorrectly operates the accelerator pedal and the brake pedal due to confusion or unskilled driving, can be prevented before happen.

1. An automatic control system for automatically keeping a car at a safe distance in traffic from any other car or an obstacle, comprising:
a sensing device 100 for sensing a car or an obstacle in front of the sensing device-equipped car in the traveling direction;
an ECU (Electronic Control Unit) 200 which is connected with the sensing device 100 and receives electric sensing signals which are transmitted from the sensing device 100, so as to render a control command according to a preset program; and
a deceleration/braking control unit 300, wherein the deceleration/braking control unit 300 comprises:
an accelerator unit 310 for automatically controlling the deceleration of the car on the basis of an electric signal from the ECU 200;
a first guide stop unit 315 for controlling the upward and downward movement of the accelerate pedal 400, the first guide stop unit 300 being operated independently of the accelerator unit 310;
a brake unit 330 for automatically controlling the braking of the car on the basis of an electric signal from the ECU 200; and
a second guide stop unit 350 for controlling the movement of a brake pedal 400′.

2. A system as claimed in claim 1, wherein the ECU 200 comprises a steering wheel rotation signal transmission unit 140 and a wiper signal transmission unit 150, which are electrically connected to the sensing device 100.

3. A system as claimed in claim 1, wherein the sensing device comprises: an external sensing unit, which includes a long-distance optical sensor 112, a short-distance optical sensor 114, and a weather change sensor 115, which perform sensing in terms of a long-distance signal, a short-distance signal, a weather change signal, a travel signal, and an accelerator pedal signal, respectively, which are inputted in the input terminal of the sensing device 100; and a traveling sensing device 130 which includes a travel velocity signal switch 132 for sensing the travel velocity of the system-installed car itself, and an accelerator pedal switch 134 which performs sensing prior to the positional variation of the accelerator pedal 400 sensed by the travel velocity signal switch 132.

4. A system as claimed in claim 1, wherein the ECU 200 comprises a solenoid 360 connected to the accelerator unit 310 so as to control the quick movement of the accelerator pedal 400.

5. A system as claimed in claim 1, wherein the first guide stop unit 315 comprises: a guide stop plate 40 which is positioned at a distance from the accelerator pedal and moves vertically according to an electric signal from the solenoid 360 connected to the accelerator unit 310; a support shaft for movably supporting the guide stop plate 40; a link 34 which is hinged to the guide stop plate 40 and reciprocates left and right with reference to the support shaft 36; a piston rod 32 connected to the link 34; a pneumatic cylinder 30, within which the piston rod 32 reciprocates left and right, the pneumatic cylinder 30 having an air inlet port 28, through which air pressure is supplied from an air compressor 26, and an air discharge port 28′ for discharging air pressure; and a base 20 for anchoring the support shaft 36 and the pneumatic cylinder 30 when the guide stop plate 40 maintains its vertical movement according to the air pressure supplied from the air compressor 26 or discharged from the pneumatic cylinder.

6. A system as claimed in claim 5, wherein when an operation signal is rendered from the ECU 200 according to a system-installed car-to-obstacle distance signal and a travel velocity signal, the guide stop plate 40 supplies a braking force in relation to the vertical movement of the accelerator pedal 400, which is linked with the guide stop plate 40.

7. A system as claimed in claim 1, wherein the second guide stop unit 350 comprises: an air compressor 26′ which is installed on the brake pedal 400′ and operated according to an electric signal of a solenoid 360′ connected to the brake unit 330; a pneumatic cylinder 50 which has an air inlet port 29, through which air pressure is supplied from the air compressor 26′, an air discharge port for discharging the air pressure, and a piston rod 52 which is reciprocated by the air pressure; and a first link 54 and a second link 56 which are hinged between the brake pedal 400′ and the pneumatic cylinder 50.

8. An automatic control system of keeping a car at a safe distance in traffic from another car or an obstacle:
a sensing device 100 for sensing a situation in front of the system-installed car in the traveling direction;
an ECU 200 connected to the sensing device 100 and receiving electric signals transmitted from the sensing device 100 as a result of sensing a car or an obstacle so as to render a control command according to a preset program;
a deceleration/braking control unit 300 having an accelerator unit 310 for automatically controlling the deceleration of the system-installed car on the basis of the electric signal from the ECU 200, a first guide stop unit 315 which operates independently of the accelerator unit 310 and controls the vertical movement of an accelerator pedal 400, a brake unit 330 for automatically controlling the braking of the system-installed car on the basis of the electric signal from the ECU 200, and a second guide stop unit 350 which operates independently of the brake unit 330 and controls the operation of a brake pedal 400′;
a steering wheel rotation signal transmission unit 140 connected to the ECU 200 for supplying a signal indicating an angular rotating range of the steering wheel to the deceleration/braking control unit 300; and
a wiper signal transmission unit 150 connected to the ECU 200, so as to cause the accelerator unit 310 to be moved up and down according to a process of operating a wiper, which is programmed in the ECU 20.

9. A control method for keeping a car at a safe distance in traffic from any other car or an obstacle, comprising steps of:
initializing all sensing signals in a sensing device 100 when a main power source of the car is switched on and the accelerating operation is initiated by an accelerator pedal 400 (S20);
determining whether a deceleration/braking control unit 300 is switched on, the deceleration/braking control unit being connected with the sensing device 100 and an ECU 200 (S30);
projecting long-distance/short-distance optical signals to an obstacle in front of the car so as to sense the obstacle from an external sensor 110 of the sensing device 100 when the deceleration/braking control unit 300 is switched on (S40);
calculating an actual distance between the car and the obstacle which is sensed in the sensing step (S40), the calculation being performed by the a calculation unit 220 of the ECU 200 (S50);
determining whether the actual distance between the car and the obstacle calculated in the calculation step (S50) is larger than a reference distance value, which is referred to by a lookup table, with reference to the lookup table, which is previously stored in a ROM 260 (S60);
operating a guide stop plate 40, so that the guide stop plate 40 moves so as to automatically move the accelerator pedal 400 to its original position, when the actual distance between the car and the obstacle calculated in the distance determination step (S60) is smaller than the reference distance value of the lookup table, the operation of the guide stop plate 40 being caused by a first guide stop unit 315 according to a signal transmitted to the first guide stop unit 315 from a traveling sensing device 130 through the ECU 200 (S70); and
operating a brake unit 330 so as to operate a second guide stop unit 350, thereby operating the brake pedal 400′ (S80).

10. A system as claimed in claim 9, wherein the step of operating the accelerator pedal (S70) comprises steps of:
causing the solenoid 360 to be opened if the car approaches near to the obstacle, so that the accelerator unit 310 receives operation signals produced by the long-distance/short-distance sensing by the ECU 200 prior to the braking signal of the brake unit 330 (S402);
operating a pneumatic cylinder 30, wherein if the accelerator unit 310 receives the operation signals (S402), the pneumatic cylinder 30 is driven by making the air inlet port 28 and air discharge port 28′ of the pneumatic cylinder 30 opened and closed, respectively, according to the operation signals applied to the input and output terminals of the solenoid 360 through a signal line (S404);
thereafter, moving a piston rod 32 within the pneumatic cylinder 30 and a link 34 connected to the piston rod 32 (S406);
moving upward the guide stop plate 40 connected to the link (S408); and
braking the upward and downward movement of the accelerator pedal 400, wherein the guide stop plate 40 supplies braking force to the accelerator pedal 400 which is linked with the guide stop plate 40, thereby braking the upward and downward movement of the accelerator pedal 400 (S410).

11. A method as claimed in claim 9, wherein the step of operating the brake pedal 400′ (S80) comprises steps of:
operating the pneumatic cylinder 50, wherein the operation of the pneumatic cylinder 50 is caused as the ECU 200 renders a command to the second guide stop unit 350 so as to operate the pneumatic cylinder 50 (S502); and
controlling the upward and downward movement of the brake pedal 400′, wherein the control of the upward and downward movement of the brake pedal is performed as the piston rod 52 of the pneumatic cylinder 50 is operated, thereby operating a first link 54 and a second link 56, which are hinged between the brake pedal 400′ and the piston rod 52 of the pneumatic cylinder 50.
